(19) United States
(12) Patent Application Publication
(10) Pub. No.: US 2009/0247182 A1
(43) Pub. Date: Oct. 1, 2009

(54) BASE STATION APPARATUS AND CHANNEL ALLOCATION METHOD

(75) Inventor: Shuichi Tamate, Tokyo (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/412,242

(22) Filed: Mar. 26, 2009

(30) Foreign Application Priority Data
Mar. 28, 2008 (JP) 2008-088311

(51) Int. Cl. H04W 72/08

(52) U.S. Cl. 455/452.2; 455/562.1

(57) ABSTRACT

A base station includes an adaptive control unit for obtaining weights (w1′ to w4′) of antenna elements indicating an arrival direction of an interference signal detected on a radio channel that is not being used for communication, and weights (w1 to w4) indicating an arrival direction of a desired signal arriving from a mobile station. The base station further includes an interference signal suppressibility determining unit for determining, based on the weights (w1 to w4) and the weights (w1′ to w4′), whether or not it is possible to form a direction pattern that directs a main beam toward the arrival direction of the desired signal and directs a null toward the arrival direction of the interference signal; and a channel allocation unit for determining, based on a result of the determination, whether to allocate the mobile station the radio channel on which the interference signal is detected.

### CROSS-REFERENCE TO RELATED APPLICATIONS

This application claims priority to Japanese Patent Application No. 2008-088311 filed Mar. 28, 2008, the disclosure of which is incorporated herein by reference in its entirety.

### BACKGROUND OF THE INVENTION

1. Field of the Invention

The present invention relates to a base station apparatus and a channel allocation method. More particularly, the present invention relates to a base station apparatus and a channel allocation method that involve adaptive array control.

2. Description of the Related Art

There have been known base stations that are equipped with a measure for suppressing interference signals which lower the communication quality.

For instance, JP 2000-82987 A (hereinafter, referred to as Patent Document 1) discloses a base station that performs interference signal detection (carrier sense) in response to a link channel establishment request (connection request) from a mobile station and allocates the mobile station a radio channel where no interference signal is detected (see FIG. 5 and Paragraph 0003 of the document). The base station disclosed in Patent Document 1 also includes an array antenna and is capable of suppressing interference signals by directing the null of an antenna direction pattern toward the direction of arrival (arrival direction) of interference signals (see Paragraph 0031 of the document).

FIG. 8 is a diagram illustrating a situation where a first mobile communication system, which includes a base station 70 and a mobile station 72, and a second mobile communication system, which includes a base station 80 and a mobile station 82, coexist in the same area. Under the situation illustrated in FIG. 8, radio waves sent out from the base station 80 could reach the base station 70 neighboring the base station 80.

Assuming that the base station 70 and the base station 80 employ orthogonal frequency division multiple access (OFDMA) system to communicate with the mobile station 72 and the mobile station 82, respectively, the spectrum of signals received at the base station 70 in this case is, for example, as illustrated in FIG. 9. FIG. 9 illustrates that the side lobe of a radio wave (5) coming in from the base station 80 breaks the orthogonality of a subcarrier (4) of a radio wave coming in from the mobile station 72 (desired signal). This makes it difficult for the base station 70 to correctly demodulate a signal transmitted on the subcarrier (4), and the signal reception quality is deteriorated.

The phenomenon is not limited to cases where the base station 70 and the base station 80 employ OFDMA system. In cases where neighboring base stations are not synchronized with each other, too, radio waves sent out from the base station 80 can interfere with communications of the base station 70.

Such interference signals can be suppressed in some cases by the adaptive array control described above. To elaborate, such interference signals can be suppressed if it is possible through directivity control using an array antenna to direct the null of the direction pattern toward the arrival direction of the interference signals.

The aforementioned conventional base station, however, allocates a mobile station only a radio channel where no interference signal is detected by carrier sense (or, where the interference signal level is smaller than a given value), regardless of whether or not interference signals can be suppressed by array antenna directivity control (see FIG. 10). There are consequently radio channels that are not used for communication merely because interference signals are detected, despite the fact that the interference signals can be suppressed. This is a problem in terms of frequency utilization efficiency.

### SUMMARY OF THE INVENTION

The present invention has been made in view of the above-mentioned problem of prior art, and an object of the present invention is therefore to provide a base station apparatus and a channel allocation method that improve frequency utilization efficiency, for example. Additional features will become readily apparent by reference to the following detailed description when taken in conjunction with the accompanying drawings.

According to one embodiment of the present disclosure, a base station apparatus that includes an array antenna including a plurality of antenna elements and that communicates with a mobile station apparatus on at least some of a plurality of radio channels, includes: interference signal arrival direction information obtaining means for obtaining interference signal arrival direction information, which indicates an arrival direction of an interference signal detected on a radio channel, among the plurality of radio channels, that is not being used for communication; desired signal arrival direction information obtaining means for obtaining desired signal arrival direction information, which indicates an arrival direction of a desired signal arriving from the mobile station apparatus; interference signal suppressibility determining means for determining, based on the desired signal arrival direction information and the interference signal arrival direction information, whether or not it is possible to form a direction pattern that directs a main beam toward the arrival direction of the desired signal and directs a null toward the arrival direction of the interference signal; and channel allocation means for determining, based on a result of the determination by the interference signal suppressibility determining means, whether to allocate the mobile station apparatus the radio channel on which the interference signal is detected.

According to an embodiment, even when an interference signal is detected on one radio channel, the base station apparatus allocates this radio channel to the mobile station apparatus if it is possible to form the direction pattern that directs the main beam toward the arrival direction of the desired signal, which comes in from the mobile station apparatus (a direction in which the mobile station apparatus is located), through beam forming and directs the null toward the arrival direction of the interference signal through null steering. According to an embodiment, a radio channel that would not be put into use in prior art is used for communication, and the frequency utilization efficiency is improved. The arrival direction information here may be, for example, angle information that indicates the arrival direction, or may be one or more pieces of vector information that indicate the arrival direction.

According to an embodiment, the interference signal suppressibility determining means executes the determination based on an angle between the arrival direction of the desired signal which is indicated by the desired signal arrival direction information and the arrival direction of the interference signal which is indicated by the interference signal arrival direction information.

According to an embodiment, whether or not suppressing an interference signal is possible can be determined based on the angle between the arrival direction of the desired signal and the arrival direction of the interference signal.

According to another embodiment, a base station apparatus further includes interference signal arrival direction information storing means for storing the interference signal arrival direction information indicating the arrival direction of the interference signal in association with a radio channel where the interference signal is detected. Further, in executing the determination, the interference signal suppressibility determining means starts with a radio channel where the angle between the arrival direction of the desired signal indicated by the desired signal arrival direction information and the arrival direction of the interference signal indicated by the interference signal arrival direction information stored in the interference signal arrival direction information storing means is large.

According to an embodiment, radio channels where the angle formed between the arrival direction of the desired signal and the arrival direction of the interference signal is large are preferentially allocated to the mobile station apparatus. The frequency utilization efficiency is thus improved while preventing the lowering of communication quality due to a change in the location of the mobile station apparatus or the like.

According to still another embodiment, a base station apparatus includes interference signal level detecting means for detecting an interference signal level in the radio channel among the plurality of radio channels that is not being used for communication. Further, in executing the determination, the interference signal suppressibility determining means starts with a radio channel where the interference signal level detected by the interference signal level detecting means is small.

According to an embodiment, among radio channels where interference signals are detected, ones that are low in interference signal level are preferentially allocated to the mobile station apparatus. The frequency utilization efficiency is thus improved while preventing the lowering of communication quality.

According to still another embodiment, interference signal arrival direction information includes respective weights (weighting factors) of the plurality of antenna elements that make a level of a combined signal, which is obtained by combining radio signals received respectively by the plurality of antenna elements, equal to or larger than a given value.

According to still another embodiment, interference signal arrival direction information includes respective weights of the plurality of antenna elements that are determined so as to direct the main beam of the direction pattern toward the arrival direction of the interference signal. It should be noted that the weights may be controlled by any one of known weight control algorithms.

According to still another embodiment, an arrival direction of the interference signal is calculated based on a plurality of pieces of the interference signal arrival direction information which are obtained at different points in time. Errors in the estimation of the arrival direction of the interference signal are thus reduced.

According to still another embodiment, desired signal arrival direction information includes respective weights of the plurality of antenna elements that are determined so as to direct the main beam of the direction pattern toward the arrival direction of the desired signal. It should be noted that the weights may be controlled by any one of known weight control algorithms.

According to an embodiment, a channel allocation method for a base station apparatus that includes an array antenna including a plurality of antenna elements and that communicates with a mobile station apparatus on at least some of a plurality of radio channels, includes the steps of: obtaining interference signal arrival direction information, which indicates an arrival direction of an interference signal detected on a radio channel, among the plurality of radio channels, that is not being used for communication; obtaining desired signal arrival direction information, which indicates an arrival direction of a desired signal arriving from the mobile station apparatus; determining, based on the desired signal arrival direction information and the interference signal arrival direction information, whether or not it is possible to form a direction pattern that directs a main beam toward the arrival direction of the desired signal and directs a null toward the arrival direction of the interference signal; and determining, based on a result of the determining, whether to allocate the mobile station apparatus the radio channel on which the interference signal is detected.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an overall configuration diagram of a mobile communication system according to an embodiment of the present disclosure;

FIG. 2 is a functional block diagram of a base station according to according to an embodiment of the present disclosure;

FIG. 3 is a configuration diagram of an adaptive array according to an embodiment of the present disclosure;

FIG. 4 is a diagram illustrating interference signal arrival direction information (weight), which is stored in a storage unit according to an embodiment of the present disclosure;

FIG. 5 is a flow chart illustrating an example of interference signal arrival direction information (weight) obtaining processing according to according to an embodiment of the present disclosure;

FIG. 6 is a flow chart illustrating an example of channel allocation processing according to according to an embodiment of the present disclosure;

FIG. 7A is a diagram illustrating the frequency utilization efficiency of a conventional base station;

FIG. 7B is a diagram illustrating the frequency utilization efficiency of the base station according to according to an embodiment of the present disclosure;

FIG. 8 is a diagram illustrating a situation where a first mobile communication system and a second mobile communication system coexist in the same area ;

FIG. 9 is a diagram illustrating spectrum of signals received at a base station ; and

FIG. 10 is a flow chart illustrating channel allocation processing in a conventional base station.

### DETAILED DESCRIPTION OF THE INVENTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

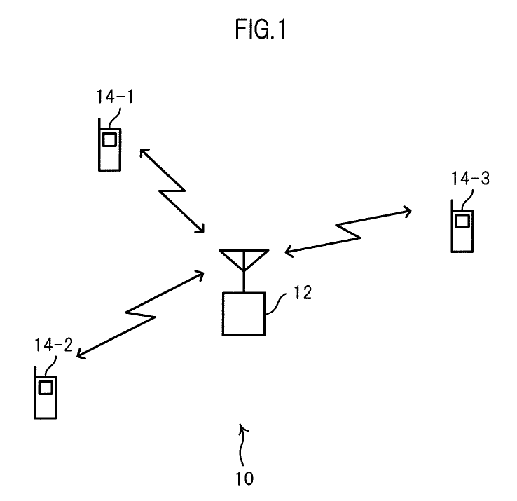

FIG. 1 is an overall configuration diagram of a mobile communication system 10 according to the embodiment of the present disclosure. As illustrated in FIG. 1, the mobile communication system 10 includes a base station 12 and a plurality of mobile stations 14 (here, only three mobile stations 14-1 to 14-3 are illustrated).

The base station 12 includes an array antenna including a plurality of antenna elements, and communicates with each of the plurality of mobile stations 14 by time division multiple access/time division duplex (TDMA/TDD) system and OFDMA system, on at least some of a plurality of radio channels. The mobile stations 14 are, for example, portable cellular phones, personal digital assistants, or communication cards.

Each time frame according to TDMA/TDD system (TDMA frame) includes, for example, four time slots for a downlink (a wireless transmission path from the base station 12 to the mobile stations 14) and four time slots for an uplink (a wireless transmission path from the mobile stations 14 to the base station 12). A plurality of subchannels (for example, 20 subchannels) each including a plurality of subcarriers (for example, 24 subcarriers) according to OFDMA system are defined in each time slot.

In the mobile communication system 10, each radio channel is identified by the combination of each of the time slots thus defined and each of the subchannels thus defined. Upon receiving a link channel establishment request signal from one mobile station 14, or when reallocating a radio channel to one mobile station 14, the base station 12 selects one or more radio channels from among the aforementioned plurality of radio channels and allocates the selected radio channel(s) to the mobile station 14.

In one embodiment, in particular, the base station 12 allocates the mobile station 14 a radio channel despite an interference signal of given level or higher being detected on the radio channel, as long as it is possible to form a direction pattern that directs a main beam toward the arrival direction of a desired signal, which comes in from the mobile station 14, through beam forming and directs the null toward the arrival direction of the interference signal through null steering. A radio channel that would not be put into use in prior art is thus used for communication, and the frequency utilization efficiency is improved as a result.

Given below is a detailed description on components and functions that the base station 12 includes in order to implement the above-mentioned processing.

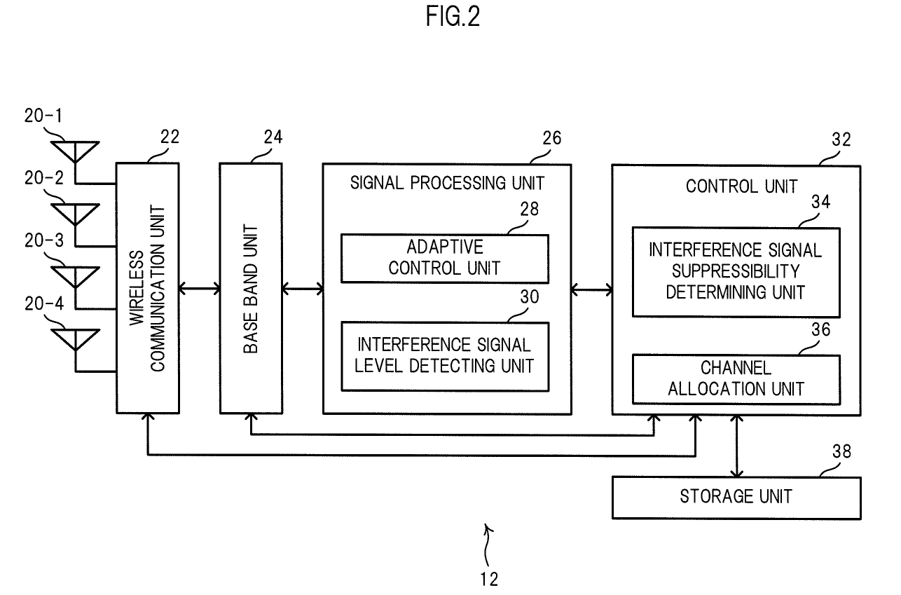

FIG. 2 is a functional block diagram of the base station 12, according to an embodiment. As illustrated in FIG. 12, the base station 12 includes a plurality of antenna elements (here, four antenna elements 20-1 to 20-4), which are low in spatial correlation with respect to one another, a wireless communication unit 22, a base band unit 24, a signal processing unit 26 (adaptive control unit 28 and interference signal level detecting unit 30), a control unit 32 (interference signal suppressibility determining unit 34 and channel allocation unit 36), and a storage unit 38.

The antenna elements 20-1 to 20-4 constitute an array antenna. Each antenna element 20 receives radio signals and outputs the received radio signals to the wireless communication unit 22. Each antenna element 20 also radiates radio signals that are supplied from the wireless communication unit 22 to the mobile stations 14. The reception and transmission of radio signals are switched by time division upon instruction from the wireless communication unit 22.

The wireless communication unit 22 is structured to include a low noise amplifier, a power amplifier, a local oscillator, a mixer, and a filter. Radio signals input from the antenna elements 20-1 to 20-4 are amplified by the low noise amplifier, then down-converted to intermediate frequency signals, and then output to the base band unit 24. Base band OFDM signals input from the base band unit 24 to the wireless communication unit 22 are up-converted to radio signals, then amplified by the power amplifier to a transmission power level, and then supplied to the antenna elements 20-1 to 20-4.

The base band unit 24 includes an OFDM demodulation unit and an OFDM modulation unit, which are not illustrated in the drawing, and is built from a DSP, for example.

The OFDM demodulation unit includes an A/D converter, a fast Fourier transform (FFT) unit, and a symbol demapper. A signal input from the wireless communication unit 22 to the OFDM demodulation unit is converted into a digital signal by the A/D converter. This digital signal is converted from serial to parallel and then converted into respective subcarrier components of a complex symbol sequence through Fourier transform executed in the FFT unit. The subcarrier components of the complex symbol sequence are converted through parallel-serial conversion into a continuous complex symbol sequence, then decoded by the symbol demapper into a data bit string (received data) according to the employed symbol modulation scheme, and then output to the signal processing unit 26.

The OFDM modulation unit includes a D/A converter, an inverse fast Fourier transform (IFFT) unit, and a symbol mapper. A data bit string (transmission data) input to the OFDM modulation unit from the signal processing unit 26 is converted by the symbol mapper into a complex symbol sequence, and then divided through serial-parallel conversion into respective subcarrier components. The subcarrier components of the complex symbol sequence are converted into sample values of an OFDM symbol through inverse Fourier transform executed in the IFFT unit, and then converted into a continuous signal through parallel-serial conversion. This continuous signal is, after converted by the D/A converter into an analog signal, output as a base band OFDM signal (modulated signal) to the wireless communication unit 22.

The above-mentioned symbol mapping processing and symbol demapping processing may be performed by the signal processing unit 26 instead, for example.

The signal processing unit 26 includes the adaptive control unit 28 and the interference signal level detecting unit 30, and is built from a digital signal processor (DSP), for example.

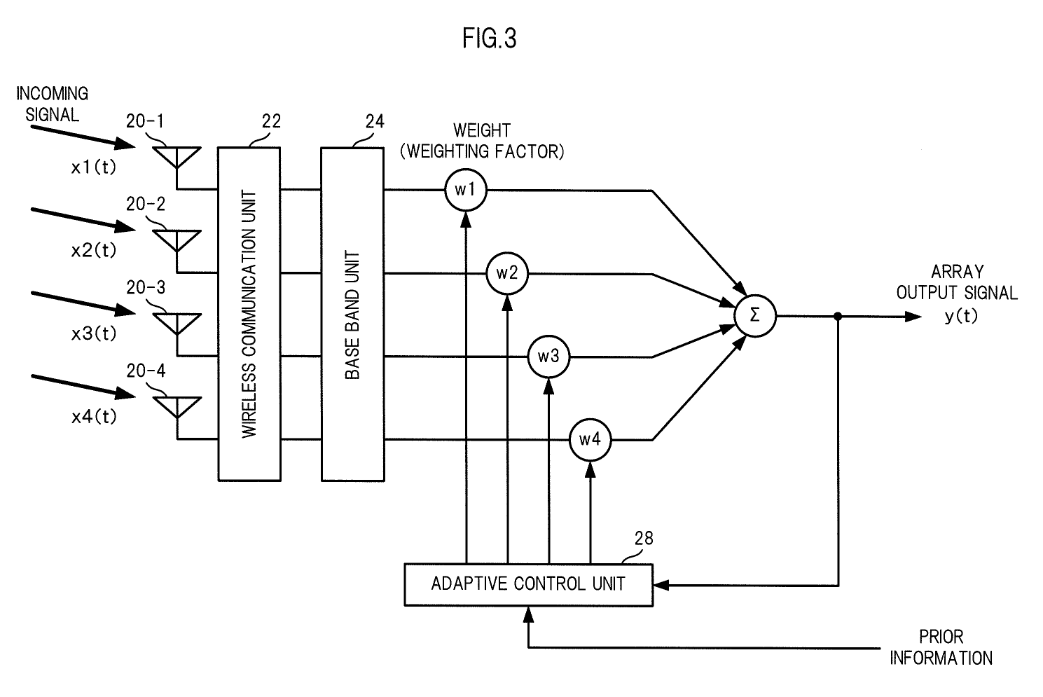

The adaptive control unit 28 controls the direction pattern of the array antenna by adjusting the weights of the antenna elements 20-1 to 20-4. Specifically, as illustrated in FIG. 3, the adaptive control unit 28 multiplies outputs (signals output from the antenna elements 20-1 to 20-4 via the wireless communication unit 22 and the base band unit 24) of the four antenna elements 20-1 to 20-4, which respectively receive incoming signals x1(t) to x4(t), by weights (weighting factors) w1 to w4, respectively. The adaptive control unit 28 controls the weights w1 to w4 such that a desired direction pattern is formed based on an array output signal y(t), which is obtained by combining those weighted signals, and given prior information.

In this embodiment, weights are controlled not only on radio channels that are being used for communication with the mobile stations 14 but also on radio channels that are not being used for communication with the mobile stations 14 (idle channels). A method of determining weights on a radio channel that is being used for communication (hereinafter, referred to as “weight determining method 1”) and a method of determining weights on an idle channel (hereinafter, referred to as “weight determining method 2”) are described separately below.

The weight determining method 1 is described first. On a radio channel that is being used for communication with one of the mobile stations 14, the adaptive control unit 28 uses a known weight control algorithm to control the weights w1 to w4 of the antenna elements 20-1 to 20-4 such that the main beam of the direction pattern is directed toward the arrival direction of a desired signal, which comes in from the mobile station 14 (beam forming), and that the null of the direction pattern is directed toward the arrival direction of an interference signal detected on this radio channel (null steering). For instance, the adaptive control unit 28 controls the weights w1 to w4 in a manner that minimizes the error between the array output signal y(t) and a known signal (reference signal) that is included at a given position in the desired signal through minimum mean square error (MMSE). The desired signal arriving from the mobile station 14 includes a link channel establishment request signal, a communication signal, and other signals sent from the mobile station 14.

The array output signal y(t) to which the thus determined weights w1 to w4 have been applied is output to an upper apparatus (not shown in the drawings), the control unit 32, or others. The determined weights are also applied to the transmission of radio signals to this mobile station 14. Specifically, the adaptive control unit 28 multiplies, respectively, signals input from the upper apparatus (not shown in the drawings), the control unit 32, or others by the weights w1 to w4 that are determined in the immediately preceding reception slot, and supplies the weighted signals to the antenna elements 20-1 to 20-4 via the base band unit 24 and the wireless communication unit 22.

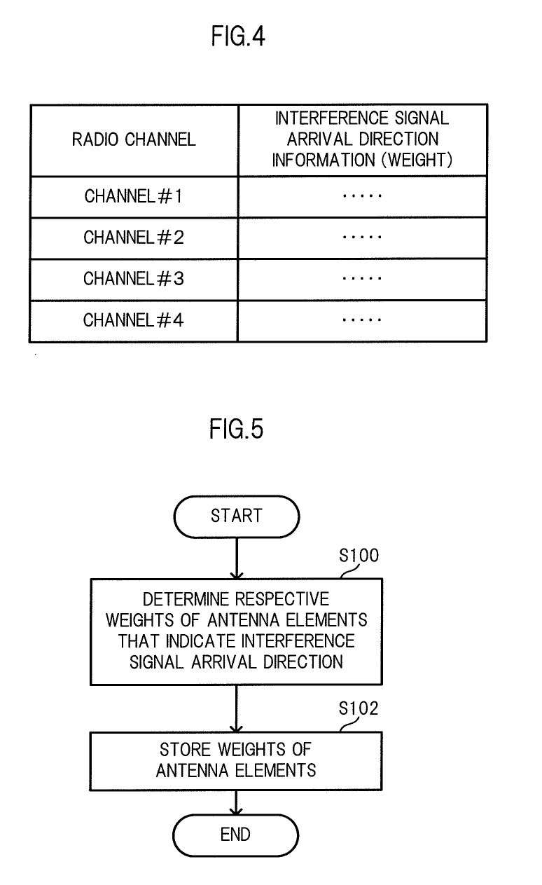

The weight determining method 2 is described next. In the following description, weights of the antenna elements 20-1 to 20-4 that are determined by the weight determining method 2 are denoted by w1′ to w4′, respectively. In an idle channel which is not being used for communication with any of the mobile stations 14, the adaptive control unit 28 obtains one or more sets of the weights w1′ to w4′ that make the level of the array output signal y(t) equal to or larger than a given value. The adaptive control unit 28 thus obtains the weights w1′ to w4′ that direct the main beam of the direction pattern toward the arrival direction of an interference signal detected on this idle channel. The weights w1′ to w4′ determined in this manner are stored as information that indicates the arrival direction of the interference signal (interference signal arrival direction information) in the storage unit 38 in association with radio channel identification information that indicates the idle channel (see FIG. 4).

In the weight determining method 2, the adaptive control unit 28 may control the weights w1′ to w4′ such that the main beam of the direction pattern is directed toward the arrival direction of an interference signal detected on the idle channel. For example, the adaptive control unit 28 may control the weights w1′ to w4′ in a manner that maximizes the array output signal y(t).

The interference signal level detecting unit 30 performs carrier sense following an instruction of the channel allocation unit 36, which is described later, and detects the reception level of a radio signal that is received over each idle channel as an interference signal level.

The control unit 32 is built from, for example, a CPU and a memory, and controls each unit of the base station 12 by having the CPU execute a program that is stored in the memory. The control unit 32 particularly includes the interference signal suppressibility determining unit 34 and the channel allocation unit 36.

The interference signal suppressibility determining unit 34 determines, upon instruction from the channel allocation unit 36, whether or not it is possible to form a direction pattern that directs the main beam toward the arrival direction of a desired signal coming in from the mobile station 14 and directs the null toward the arrival direction of an interference signal detected on an idle channel that is specified by the channel allocation unit 36.

Whether the direction pattern can be formed or not is determined based on the weights w1 to w4, which are determined by the above-mentioned weight determining method 1, and the weights w1′ to w4′, which are determined by the above-mentioned weight determining method 2. As described above, the weights w1 to w4 are determined by the weight determining method 1 such that the main beam of the direction pattern is directed toward the arrival direction of the desired signal, and indicate the desired signal arrival direction. The weights w1′ to w4′ are determined by the weight determining method 2 such that the level of the array output signal y(t) is equal to or higher than the given value, and indicate the interference signal arrival direction.

The interference signal suppressibility determining unit 34 reads out of the storage unit 38 the weights w1′ to w4′ that have been stored in association with the idle channel specified by the channel allocation unit 36, and calculates the angle between the desired signal arrival direction indicated by the weights w1 to w4 and the interference signal arrival direction indicated by the read weights w1′ to w4′. The interference signal suppressibility determining unit 34 evaluates whether or not the calculated angle is equal to or larger than a given angle, to thereby determine whether or not it is possible to form a direction pattern that directs the main beam toward the arrival direction of the desired signal coming in from the mobile station 14 and directs the null toward the arrival direction of the interference signal detected on the idle channel that is specified by the channel allocation unit 36. Multiple signal classification (MUSIC) and other known calculation methods can be used to obtain the interference signal arrival direction and the desired signal arrival direction from the weights, or to obtain the angle between these arrival directions from the weights.

Upon receiving a link channel establishment request signal from one mobile station 14, or when reallocating a radio channel to one mobile station 14, the channel allocation unit 36 decides on a radio channel to be allocated to the mobile station 14, and notifies the mobile station 14 of the decided radio channel.

The channel allocation unit 36 has the interference signal level detecting unit 30 perform carrier sense first before deciding on a radio channel to be allocated to the mobile station 14, in order to determine whether or not there is an idle channel on which the interference signal level is smaller than a given value. In the case where an idle channel on which the interference signal level is smaller than the given value is found, the channel allocation unit 36 allocates this idle channel to the mobile station 14.

On the other hand, in the case where the interference signal level is equal to or higher than the given value on every idle channel, the channel allocation unit 36 selects one or more allocation candidate channels from among the idle channels, and has the interference signal suppressibility determining unit 34 perform the above-mentioned determination process for each allocation candidate channel. If the interference signal suppressibility determining unit 34 determines as a result that it is possible to form a direction pattern that directs the main beam toward the arrival direction of the desired signal coming in from the mobile station 14 and directs the null toward the arrival direction of the interference signal detected on the allocation candidate channel, the channel allocation unit 36 allocates this allocation candidate channel to the mobile station 14. Criteria for selecting an allocation candidate channel are described later.

The operation of the base station 12, according to one exemplary embodiment, is described next.

FIG. 5 is a flow chart illustrating an example of interference signal arrival direction information (the weights w1′ to w4′ of the antenna elements 20-1 to 20-4) obtaining processing, which is executed by the base station 12. This processing is executed regularly, or when a channel is freed up, or upon other events.

As illustrated in FIG. 5, the base station 12 determines the respective weights w1′ to w4′ of the antenna elements 20 in a manner that maximizes an array output signal relevant to a radio signal (interference signal) received over an idle channel (S100). The base station 12 stores the determined weights w1′ to w4′ in the storage unit 38 in association with channel identification information that identifies this idle channel (S102).

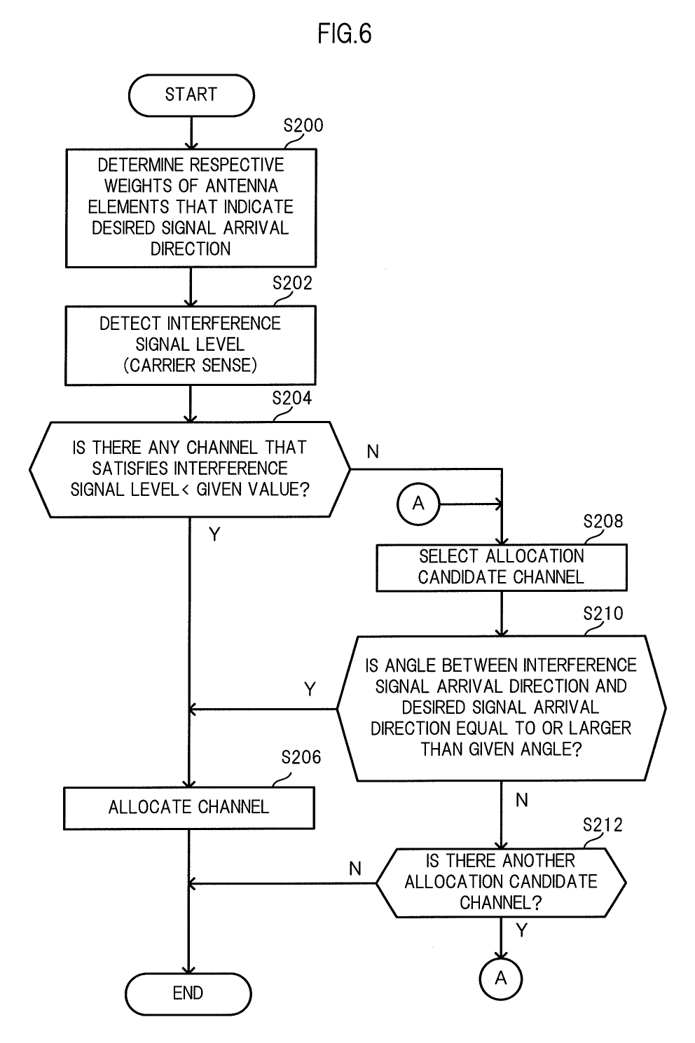

FIG. 6 is a flow chart illustrating an example of channel allocation processing, which is executed by the base station 12. This processing is executed when the base station 12 receives a link channel establishment request signal from one mobile station 14, or when the base station 12 reallocates a radio channel to one mobile station 14.

As illustrated in FIG. 6, the base station 12 determines the respective weights w1 to w4 of the antenna elements 20 in a manner that minimizes the error between an array output signal relevant to a desired signal arriving from the mobile station 14 and a known signal (S200). The base station 12 next detects through carrier sense the interference signal level on each idle channel (S202), and determines whether or not there is an idle channel on which the interference signal level is smaller than a given value (S204). If an idle channel on which the interference signal level is smaller than the given value is found as a result, the base station 12 allocates this idle channel to the mobile station 14 (S206).

When there is no idle channel on which the interference signal level detected in S202 is smaller than the given value, on the other hand, the base station 12 selects an allocation candidate channel from among the idle channels (S208). For example, the base station 12 preferentially selects idle channels where the interference signal level detected in S202 is small as allocation candidate channels.

The base station 12 next reads out of the storage unit 38 the weights w1′ to w4′ that have been stored in association with the allocation candidate channel, and determines whether or not the angle between a desired signal arrival direction that is indicated by the weights w1 to w4 determined in S200 and an interference signal arrival direction that is indicated by the read weights w1′ to w4′ is equal to or larger than a given angle (S210). When the angle is found to be equal to or larger than the given angle, the base station 12 allocates this allocation candidate channel to the mobile station 14 (S206). When the angle is found to be smaller than the given angle, on the other hand, the base station 12 determines whether or not there is another allocation candidate channel (S212). When there is another allocation candidate channel, the base station 12 executes S208 and subsequent steps. When there are no other allocation candidate channels, the base station 12 ends this channel allocation processing without allocating any radio channel to the mobile station 14.

Instead of executing S208 to S210 described above, the base station 12 may perform for each idle channel the reading of the storage unit 38 to read the weights w1′ to w4′ that have been stored in association with the idle channel, to calculate the angle between a desired signal arrival direction that is indicated by the weights w1 to w4 determined in S200 and an interference signal arrival direction that is indicated by the read weights w1′ to w4′, and to determine whether or not the calculated angle is equal to or larger than a given angle for each idle channel in descending order of the calculated angle. In the case where the maximum value of the angle between the desired signal arrival direction and the interference signal arrival direction is smaller than the given angle, the base station 12 may end the channel allocation processing without executing S212.

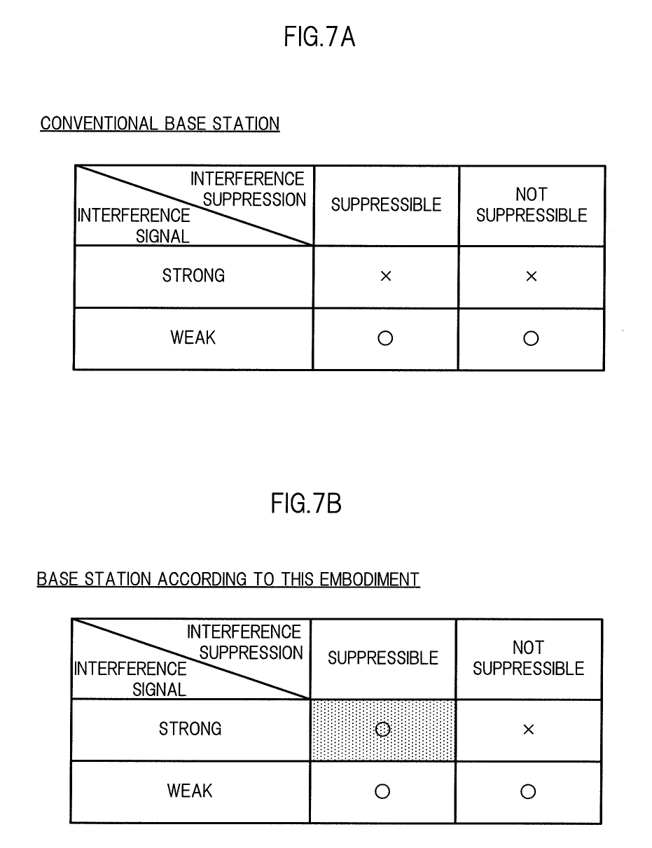

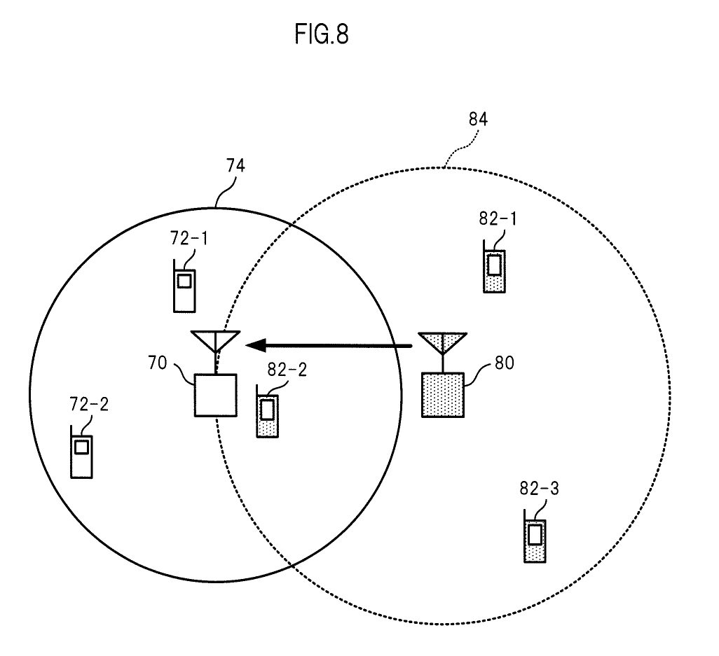

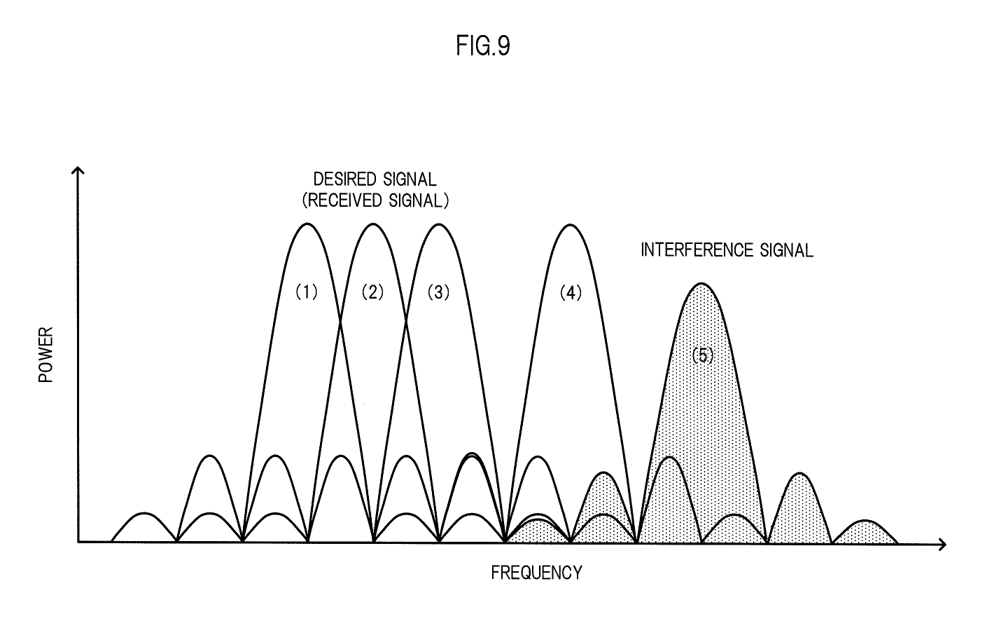

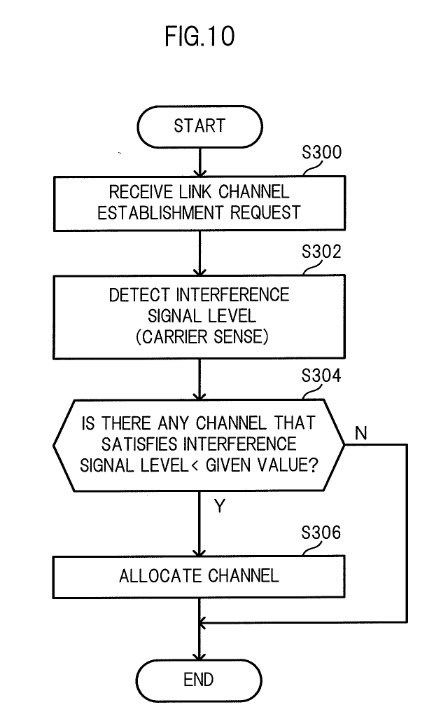

According to the above-mentioned mobile communication system 10, the base station 12 allocates a radio channel to the mobile station 14 despite an interference signal of given level or higher being detected on the radio channel, as long as it is possible to form a direction pattern that directs the main beam toward the arrival direction of a desired signal, which comes in from the mobile station 14, through beam forming and directs the null toward the arrival direction of the interference signal through null steering. Therefore, as illustrated in FIGS. 7A and 7B, a radio channel that would not be put into use in prior art (a radio channel where the interference signal level is high but suppressible through adaptive array control) is used for communication, and the frequency utilization efficiency is improved as a result.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

For instance, the present invention is widely applicable to base stations that include an array antenna and determine a radio channel to be allocated to a mobile station based on results of carrier sense. Further, interference signals targeted by the present invention are not limited to ones arriving from a neighboring base station or a base station at a close distance, but include all radio waves that interfere with communication between the base station and a mobile station. In the above-mentioned embodiment, the interference signal arrival direction may be calculated based on the weights w1′ to w4′ that are obtained at different points in time, in order to reduce errors in the estimation of interference signal arrival direction.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A base station apparatus that includes an array antenna including a plurality of antenna elements and that communicates with a mobile station apparatus on at least some of a plurality of radio channels, comprising:
interference signal arrival direction information obtaining means for obtaining interference signal arrival direction information, which indicates an arrival direction of an interference signal detected on a radio channel, among the plurality of radio channels, that is not being used for communication;
desired signal arrival direction information obtaining means for obtaining desired signal arrival direction information, which indicates an arrival direction of a desired signal arriving from the mobile station apparatus;
interference signal suppressibility determining means for determining, based on the desired signal arrival direction information and the interference signal arrival direction information, whether or not it is possible to form a direction pattern that directs a main beam toward the arrival direction of the desired signal and directs a null toward the arrival direction of the interference signal; and
channel allocation means for determining, based on a result of the determination by the interference signal suppressibility determining means, whether to allocate the mobile station apparatus the radio channel on which the interference signal is detected.

2. A base station apparatus according to claim 1, wherein the interference signal suppressibility determining means executes the determination based on an angle between the arrival direction of the desired signal which is indicated by the desired signal arrival direction information and the arrival direction of the interference signal which is indicated by the interference signal arrival direction information.

3. A base station apparatus according to claim 2, further comprising interference signal arrival direction information storing means for storing the interference signal arrival direction information indicating the arrival direction of the interference signal in association with a radio channel where the interference signal is detected,
wherein, in executing the determination, the interference signal suppressibility determining means starts with a radio channel where the angle between the arrival direction of the desired signal indicated by the desired signal arrival direction information and the arrival direction of the interference signal indicated by the interference signal arrival direction information stored in the interference signal arrival direction information storing means is large.

4. A base station apparatus according to claim 1, further comprising interference signal level detecting means for detecting an interference signal level in the radio channel among the plurality of radio channels that is not being used for communication,
wherein, in executing the determination, the interference signal suppressibility determining means starts with a radio channel where the interference signal level detected by the interference signal level detecting means is small.

5. A base station apparatus according to claim 1, wherein the interference signal arrival direction information comprises respective weights of the plurality of antenna elements that make a level of a combined signal, which is obtained by combining radio signals received respectively by the plurality of antenna elements, equal to or larger than a given value.

6. A base station apparatus according to claim 1, wherein the interference signal arrival direction information comprises respective weights of the plurality of antenna elements that are determined so as to direct the main beam of the direction pattern toward the arrival direction of the interference signal.

7. A base station apparatus according to claim 1, wherein the arrival direction of the interference signal is calculated based on a plurality of pieces of the interference signal arrival direction information which are obtained at different points in time.

8. A base station apparatus according to claim 1, wherein the desired signal arrival direction information comprises respective weights of the plurality of antenna elements that are determined so as to direct the main beam of the direction pattern toward the arrival direction of the desired signal.

9. A channel allocation method for a base station apparatus that includes an array antenna including a plurality of antenna elements and that communicates with a mobile station apparatus on at least some of a plurality of radio channels, comprising the steps of:
obtaining interference signal arrival direction information, which indicates an arrival direction of an interference signal detected on a radio channel, among the plurality of radio channels, that is not being used for communication;
obtaining desired signal arrival direction information, which indicates an arrival direction of a desired signal arriving from the mobile station apparatus;
determining, based on the desired signal arrival direction information and the interference signal arrival direction information, whether or not it is possible to form a direction pattern that directs a main beam toward the arrival direction of the desired signal and directs a null toward the arrival direction of the interference signal; and
determining, based on a result of the determining whether or not it is possible to form the direction pattern, whether to allocate the mobile station apparatus the radio channel on which the interference signal is detected.

10. A base station apparatus according to claim 2, further comprising interference signal level detecting means for detecting an interference signal level in the radio channel among the plurality of radio channels that is not being used for communication,
wherein, in executing the determination, the interference signal suppressibility determining means starts with a radio channel where the interference signal level detected by the interference signal level detecting means is small.

11. A base station apparatus according to claim 3, further comprising interference signal level detecting means for detecting an interference signal level in the radio channel among the plurality of radio channels that is not being used for communication,
wherein, in executing the determination, the interference signal suppressibility determining means starts with a radio channel where the interference signal level detected by the interference signal level detecting means is small.
